(19) United States
(12) Patent Application Publication
(10) Pub. No.: US 2015/0360605 A1
(43) Pub. Date: Dec. 17, 2015

(54) VEHICLE VISOR VANITY LIGHT AND ACTUATOR ASSEMBLY

(71) Applicant: INNOTEC, CORP., Zeeland, MI (US)

(72) Inventors: Michael L. Lanser, Holland, MI (US); Luke T. Bredeweg, Byron Center, MI (US); Matthew S. Weeda, Hudsonville, MI (US); Justin P. Boetsma, Zeeland, MI (US); Steven T. Dyk, Zeeland, MI (US); Paul A. Kramer, Holland, MI (US)

(21) Appl. No.: 14/763,012

(22) PCT Filed: Feb. 5, 2014
(86) PCT No.: PCT/US2014/014761

§ 371 Date: Jul. 23, 2015

Related U.S. Application Data
(60) Provisional application No. 61/842,610, filed on Jul. 3, 2013.
(60) Provisional application No. 61/761,541, filed on Feb. 6, 2013.

(51) Int. Cl. B60Q 3/02; B60Q 3/00

(52) U.S. Cl. CPC B60Q 3/0226; B60Q 3/004; B60Q 3/0296

(57) ABSTRACT

The specification discloses a vehicle visor including a vanity light assembly and an actuator assembly. The visor vanity additionally includes a mirror and a movable mirror cover. The light assembly includes a light source and a light pipe for conveying light from the light source to two or more diffusers, for example, on opposite ends of the mirror. The actuator assembly includes a switching arrangement for switching the light source on and off without flicker or noise in response to the opening and closing of the mirror cover.

### BACKGROUND OF THE INVENTION

The present invention relates to lighting, and more particularly to vanity lighting for vehicle visors.

Various types of vehicle visor vanity lighting have been developed. Typically, the visor includes a mirror, and the lighting may be configured to illuminate the space in front of the mirror to illuminate, for example, the face of a person using the mirror. Typically, the lighting includes lights at opposite ends of the mirror.

Lighted visor vanity arrangements may suffer from various drawbacks. First, the lighting assemblies are relatively expensive. Second, the multiple lights on a single visor vanity may vary in color and intensity, creating both aesthetic and functional issues. Such variations are attributable to variations within tolerances in light sources and/or variations in the circuits powering the light sources. Third, the lighting assemblies may have undesired physical depth or thickness, requiring undesired depth or thickness in the visor.

The lighted visor vanity arrangements include switches. Current methods of actuating vanity lights include automatic switching, in which the opening and the closing of the mirror cover turns the light on and off respectively. Current methods further include manual switching, in which a switch is provided for manual actuated by a vehicle occupant.

Known switching arrangements have various drawbacks. The current methods of actuation include the use of mechanical push-style switches or wiper/whisker style switches. These methods can cause several quality-associated drawbacks as well as functional drawbacks. Light flicker can occur during the actuation of a wiper switch due to the intermittent discontinuity between the two conductors while in relative motion. Further, the switches can have a rough motion and/or can create noise during the operation of the mirror cover. In the case of a push-style switch, an undesirable “click” noise is often heard during the actuation of the switch. Current switching mechanisms also are relatively large physically.

### SUMMARY OF THE INVENTION

In a first aspect of the invention, the aforementioned drawbacks are overcome by the present invention comprising a vehicle visor vanity lighting assembly including a light source and a light pipe delivering the light from the light source to two separate diffusers or other light outputs. The light source may be, for example, a light emitting diode (LED). The light pipe comprises a first portion that receives light from the LED light source and two light guide portions that conduct light to the outputs.

In a current embodiment, the first portion of the light pipe may comprise a central portion, and the pair of light guide portions may extend in generally opposite directions away from the central portion. Each light guide portion terminates in a diffuser spaced apart from the central portion. The light distribution may be symmetrical about a center plane, and light from the light source may be divided evenly such that about half of the light is transmitted through each light guide portion.

Although the present invention has been summarized in conjunction with a lighted vehicle visor vanity, the concepts may be embodied in other vehicle parts, components, locations, and applications. Further, the concepts may be embodied in a lighted sign or the like for buildings or other such stationary applications.

The lighting assembly of the present invention provides several advantages. First, the assembly reduces cost by reducing the number of light sources and the associated supporting circuitry. Second, the assembly reduces, and indeed eliminates, variations in the color harmony (e.g. the color or character of light) emitted by multiple light sources or as otherwise outputted at multiple locations. Third, the assembly requires a smaller physical space, enabling the visor or other supporting component to be thinner or otherwise smaller.

In a second aspect of the invention, the aforementioned drawbacks are overcome by the present invention comprising a vehicle visor vanity lighting assembly including a light source and a proximity style switch or sensor. The sensor or switch may use the vanity cover to actuate the switch/sensor to turn the vanity light on and off. The proximity switch may be, for example, a reed switch, a Hall Effect sensor, a thru-beam sensor, or a reflective sensor. In the case of a reed switch or a Hall Effect sensor, the magnet may be over-molded into the cover of the vanity. During the operation the vanity cover, the magnetic field around the magnet switch or sensor will decrease or increase, thereby changing the status of the sensor or switch. In the case of a thru beam style sensor, a molded cover tab, or other portion of the cover, may be used to selectively block the thru-beam. In the case of a reflective sensor, a reflector supported on the cover may be used to selectively reflect the beam.

These and other advantages and features of the invention will be more fully understood and appreciated by reference to the description of the current embodiments and the drawings.

### BRIEF DESCRIPTION OF THE DRAWINGS

FIG. 1 is an isometric view of a vehicle visor vanity according to one embodiment of the present invention;

FIG. 2 is an exploded isometric view of the visor vanity of FIG. 1;

FIG. 3 is an exploded isometric view of the light pipe and tray of the light assembly for the visor vanity;

FIG. 4 is a partially fragmentary cross-sectional view of the assembled tray and the light source taken along the line IV-IV in FIG. 3;

FIG. 5 is an enlarged fragmentary perspective view of an alternative light entrance for the light pipe;

FIG. 6 is a perspective view of a first alternative light pipe;

FIG. 7 is an enlarged fragmentary perspective view of one diffuser of the first alternative light pipe;

FIG. 8 is a top view of a second alternative light pipe;

FIG. 9 is a side view of the second alternative light pipe;

FIG. 10 is an enlarged fragmentary perspective view of the interface of the light pipe and the tray;

FIG. 11 is an enlarged fragmentary perspective view of an alternative tray;

FIG. 12 is a perspective view of a first switching arrangement for the light source;

FIG. 13 is a perspective view of a second switching arrangement for the light source;

FIG. 14 is a side view of the second switching arrangement with the cover closed;

FIG. 15 is a side view of the second switching arrangement with the cover opened;

FIG. 16 is a perspective view of a third switching arrangement for the light source;

FIG. 17 is an enlarged perspective view of the third switching arrangement;

FIG. 18 is a perspective view of a fourth switching arrangement for the light source; and

FIG. 19 is a side view of the fourth switching arrangement with the cover opened.

### DESCRIPTION OF THE CURRENT EMBODIMENTS

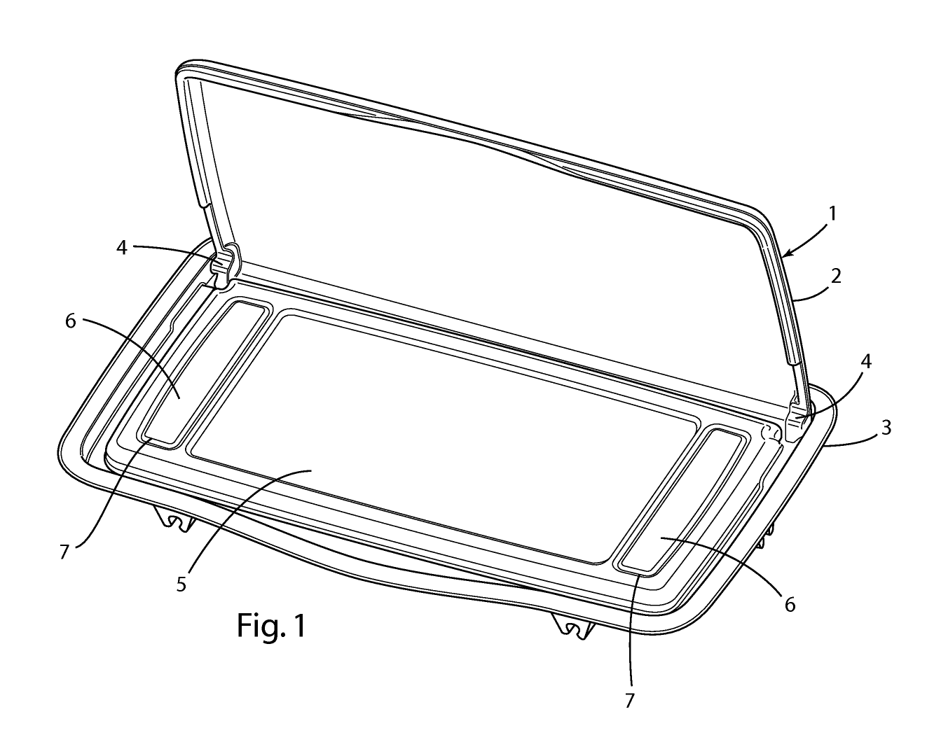

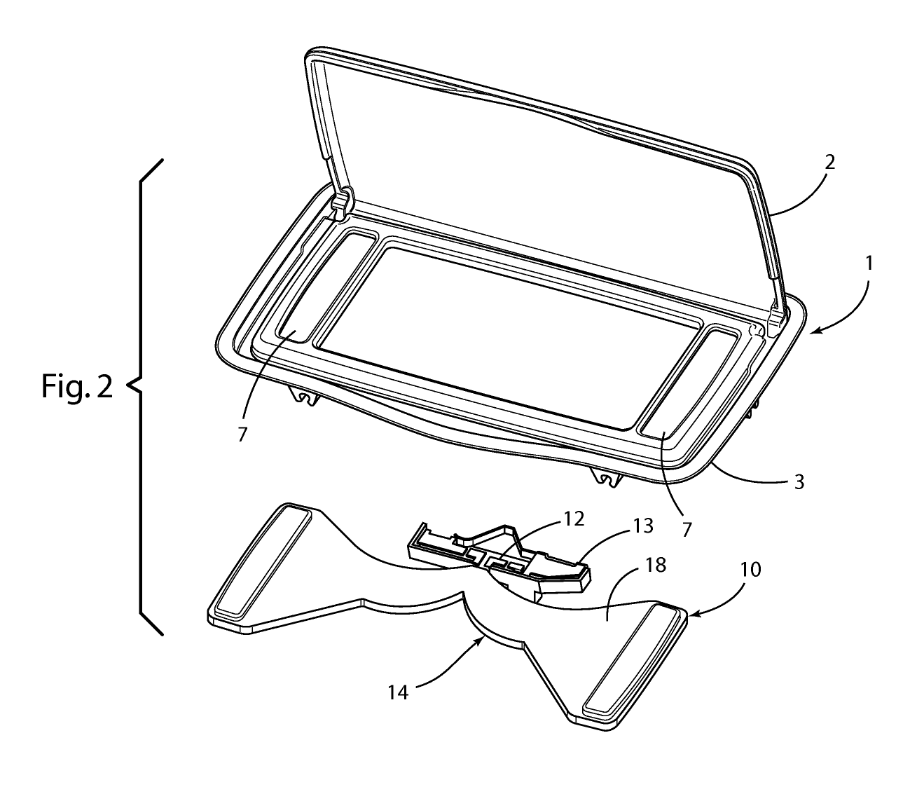

With reference to FIG. 1, a lighted accessory according to one aspect of the present invention comprises a vehicle sun visor vanity 1. The visor vanity 1 includes a movable cover 2 that is hingedly connected to a housing or support structure 3 by hinges 4 in a known manner. The support structure 3 may include a mirror 5 for use by a vehicle occupant. The cover 2 and the support structure 3 may comprise molded polymer or any other suitable material. A pair of diffusers 6 of a light pipe or light distribution member 14 (FIG. 2) are disposed within openings 7 of the support structure 3 adjacent or proximate the opposite ends of the minor 5.

With further reference to FIG. 2, a light assembly 10 of or for the visor vanity 1 includes a light source 12 and a light guide or light pipe 14 that conveys light from the light source 12 to the diffusers 6. The light pipe 14 may be a single piece or multiple pieces. The diffusers 6 may be integral with the light pipe 14.

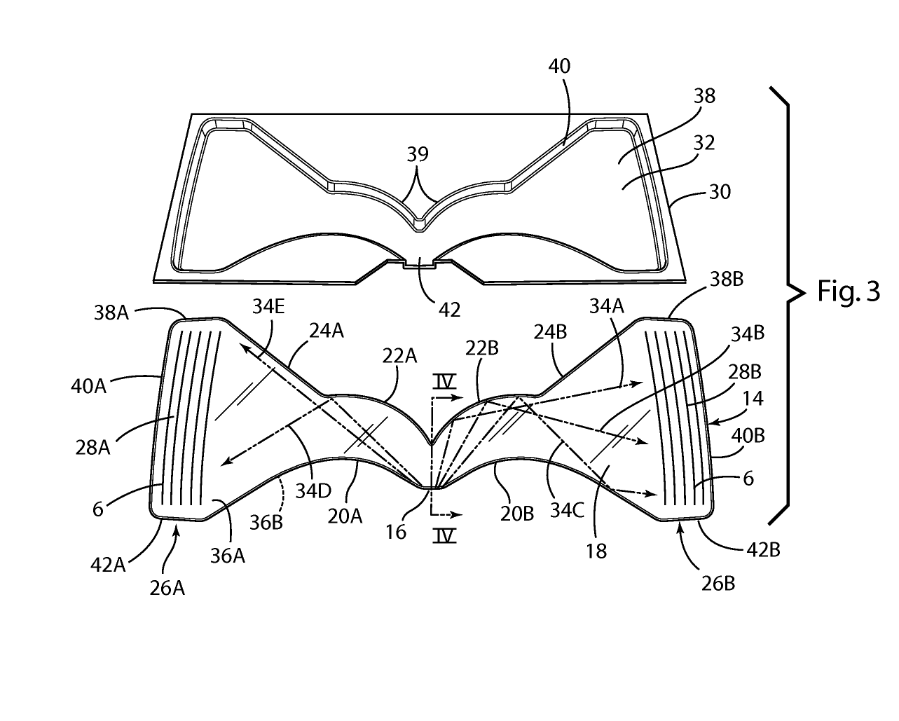

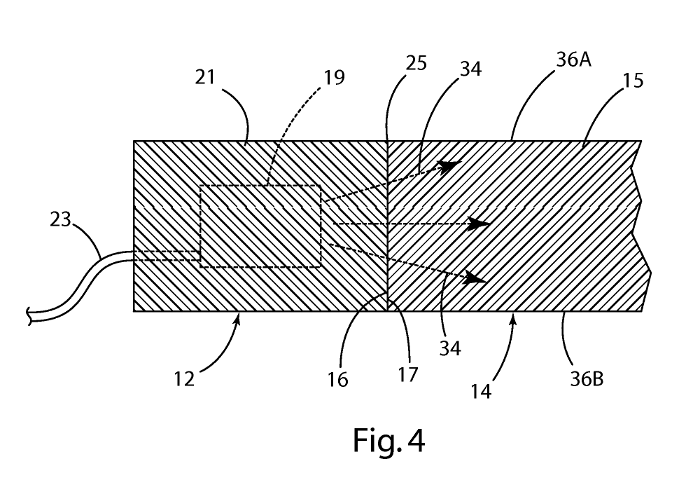

The light pipe 14 preferably is transparent and may be a transparent polymer material. Alternatively, the member 14 may be translucent in whole or in part and may be fabricated of other suitable materials. With further reference to FIGS. 3 and 4, the light pipe 14 includes a generally planar edge surface 16 that is located at a central portion of the light pipe 14.

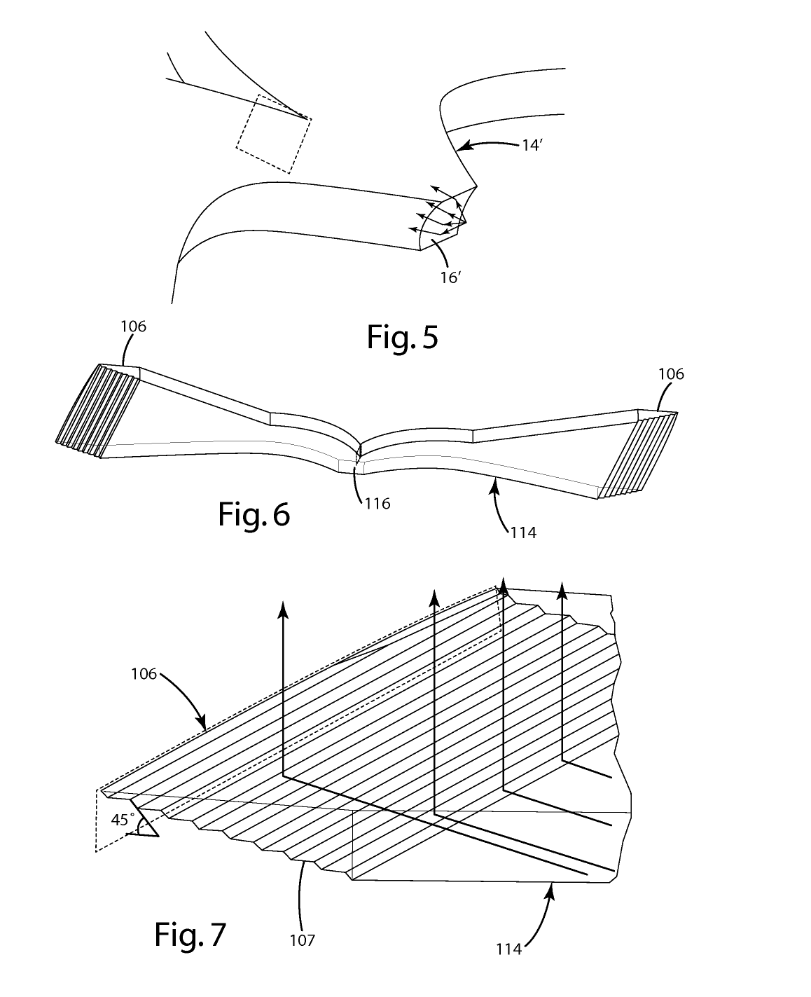

The light source 12 includes a planar surface 17 that may be positioned immediately adjacent, or in contact with, the surface 16 of the light pipe 14, such that light 34 from the light source 12 is emitted into the interior 15 of the light pipe 14. A transparent adhesive material (not shown) may be included at the interface 25 between the surfaces 16 and 17 to enhance the transmission of the light 34 from the light source 12 into the light pipe 14. Alternatively, an air gap may be provided between the surfaces 16 and 17. Preferably, and as illustrated in FIG. 5, the surfaces 16 and the corresponding surface 17 (not shown) may be shaped, for example conically, to enhance the efficiency of light flux capture from the light source 12.

The light source 12 may include one or more white LEDs 19 and related electrical components that are encapsulated in a transparent polymer material 21 as described in one or more of U.S. Pat. Nos. 6,382,697; 6,799,875; 7,152,901; 7,416,239; 7,556,759; 7,380,852; 7,528,335; 7,325,854; 7,909,482; 7,837,359; 8,230,575; 7,815,339; 7,712,933; and 8,408,773, the entire contents of each of which are incorporated by reference. The related electrical components are known to those skilled in the art, and are included to drive/power the LED(s) 19. If a single LED is utilized, the light emitted at elements 6 will have the same color “temperature”. Thus, potential differences in color between the two ends of the mirror that may result from differences in LEDs (e.g. due to production tolerances and the like) are eliminated. LEDs are currently preferred for their efficiency, reliability, and relatively low operating temperature. However, other light sources, devices, and/or combinations thereof may be used. And while white LEDs are preferred for the described application, other color LEDs and/or combinations of other color LEDs may be used depending on the application and desired aesthetics and functionality.

The light from the light source 12 may be split evenly between the diffusers 6 of the light pipe 14. This arrangement provides two or more spaced apart light sources utilizing a single LED, thereby reducing cost relative to utilizing two or more LEDs. While an even splitting or division is preferred for the current application, uneven divisions may be preferred for other applications. And while a division between two diffusers 6 is described, a division between more than two diffusers or light outputs may be preferred for other applications. For example, the light 34 could be split four ways with diffusers at the top and the bottom of the mirror in addition to the two ends of the mirror.

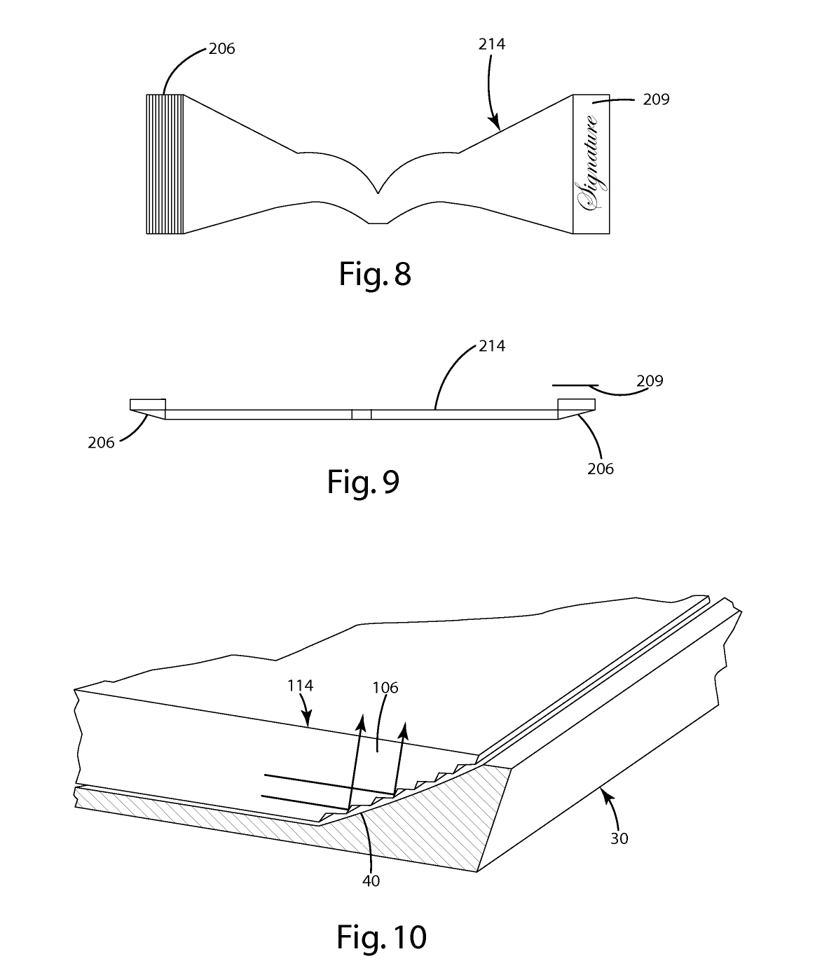

Electrical wires or lines 23 may be included to provide power to the LED(s) 19 and the related electrical components. The LED(s) 19 and the related electrical components may be molded integrally with the light pipe 14 to form an integrated assembly that does not include an interface 25. The surfaces 16 and 17 at the interface 25 may form interlocking “puzzle piece” structures as shown in FIGS. 8-11 of U.S. Pat. No. 7,712,933 to Fleischmann et al. The light source 12 may be supported within a housing 13 (FIG. 2) that is secured to the light pipe 14 and/or to the support structure 3.

Referring again to FIG. 3, the light pipe 14 includes a plate-like body portion 18 having generally planar opposite side walls 36A and 36B (see also FIG. 4) that reflect light 34 internally. The opposite side walls 36A and 36B may be substantially parallel to one another whereby the light pipe has a generally constant thickness. The body portion also includes concave curved edge surfaces 20A and 20B, convex edge surface portions 22A and 22B, generally straight edge portions 24A and 24B, and end edge surfaces 38A, 38B, 40A, 40B, 42A and 42B. The edge portions 20A, 20B, 22A, 22B, 24A, 24B, 36A, 38B, 40A, 40B, 42A and 42B extend transversely between surfaces 36A and 36B and internally reflect light from the light source 12.

The opposite end portions 26A and 26B of the light pipe 14 include surface features 28A and 28B that form diffusers 6. The surface features 28A and 28B may comprise rough or frosted surfaces formed by laser surface treatment or the like. Alternatively, surface features 28A and 28B may comprise a plurality of generally parallel raised ridges or other suitable surface features that provide for escape/emission of light rather than internal reflection. The light pipe 14 may be molded from thermoplastic polymer material, and the surface features 28A, 28B may be formed during the molding process. Alternatively, the light pipe 14 may be cut from a sheet of transparent polymer or other suitable material, and the surface features 28A and 28B may be formed utilizing secondary molding processes or other surface treatment processes (e.g. use of lasers or abrasives to create irregular surface features).

In use, the light 34 from the light source 12 travels into the light pipe 14 through the surface 16. The side edge surfaces 20A, 20B, 22A, 22B, 24A, and 24B cause the light to internally reflect inside the light pipe 14 and thereby travel from the surface 16 to the end portions 26A and 26B of the light pipe 14 as shown by the rays 34A-34E (FIG. 3). The surface features 28A and 28B are shaped such that the light inside the light pipe 14 exits at the surface features 28A and 28B. The light pipe 14, including its several surfaces, may be configured to provide a desired light path having a desired efficiency between the entrance surface 16 and the diffusers 6. For example, the splitter lens or first-reflection surface 39 opposite the light entrance surface 16 may be parabolic or alternatively may be another conic, a pyramid, a Fresnel, or any other suitable shape. The several surfaces of the light pipe 14 may be formed using molding, machining, laser ablation, printing or any other suitable technique. The light source 12 and the light pipe 14 are preferably configured such that light 34 from the light source is split evenly between the two diffusers 6. It will be understood that light pipe 14 may include three or more areas having surface features 28A, 28B, etc. to thereby provide three or more light sources that are spaced apart from a single LED light source 12.

A first alternative light pipe 114 is illustrated in FIGS. 6-7. With the exception of the diffusers 6, the light pipe 114 is generally the same as the previously described light pipe 14. The difference is that each diffuser 107 includes a stair-stepped rear surface. Each “tread” of each stair step is generally parallel to the face of the light pipe 14. Each “riser” of each stair step is oriented at approximately a 45-degree angle to the face of the light pipe 14. Other orientations of the “treads” and “risers” may be selected depending on desired aesthetics and functionality. The light traveling within the light pipe 114 from the light source 12 reflects off the stair-stepped rear surface and exits through the front of the diffuser 107.

A second alternative light pipe 214 is illustrated in FIGS. 8-9. The light pipe 214 is generally the same as the previously described light pipes 14 and 114. However, the light pipe 214 additionally includes an appliqué 209 on one or both of the diffusers 206. The applique 209 may include a trademark, logo, graphic, design, or other information. Although one applique 209 is illustrated, appliques may be included on both diffusers 206. For clarity, in FIG. 9 the applique 209 is shown separated from the light-outputting member 206; in reality, the applique would be on the diffuser. The information on the applique also could be provided directly on or in the diffuser 209, for example by in-molding, inscribing, etching, or any other suitable technique.

The visor vanity 1 may include a tray or tub 30 (FIG. 3) having a generally planar base surface 38 and a side wall 40 forming a shallow cavity or pocket 32 that is shaped and dimensioned to closely receive the light pipe 14. The sidewall 40 defines an opening 42 that accommodates LED light source 12. The tray 30 may be formed from polymer or other suitable material. The tray 30 may be secured to the support structure 3 to form an internal cavity that receives the light source 12 and the light pipe 14. The light source 12 and the light pipe 14 are thereby substantially enclosed within the support structure or housing 3.

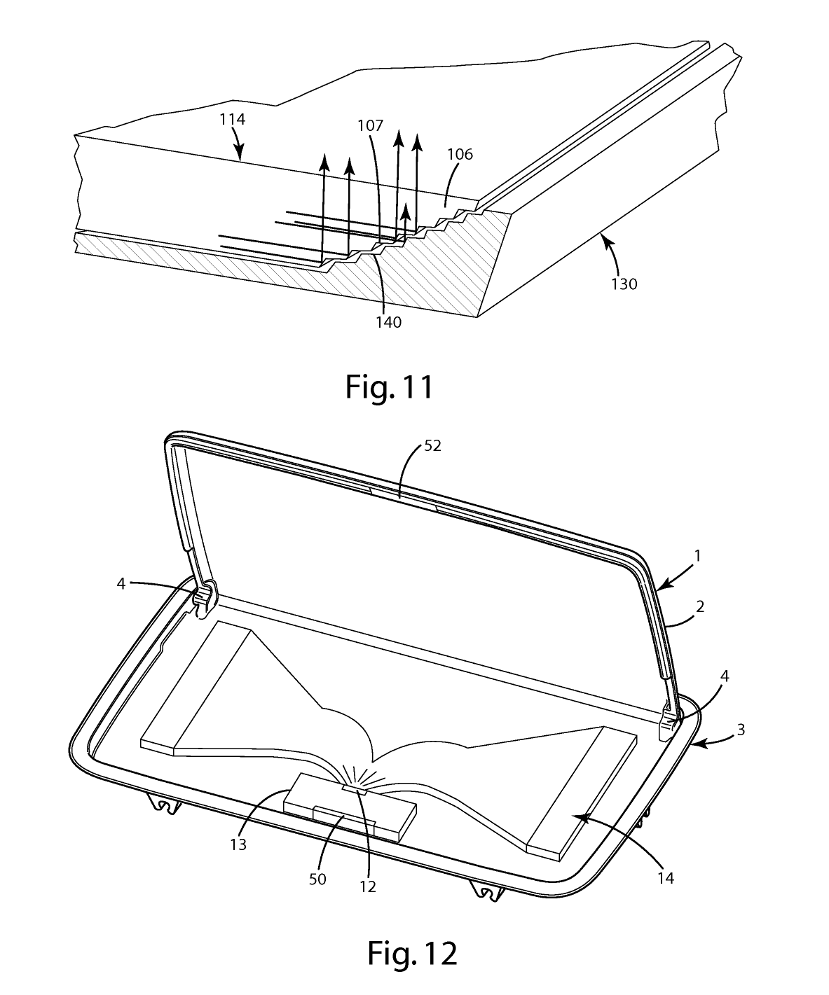

The tub 30 reflects escaped light back into the light pipe 14. The tub 30 may be white and/or otherwise reflective. The sidewall 40 may be configured to enhance the reflection of escaped light back into the light pipe 14. A sidewall 40 having a surface gradient is illustrated in FIGS. 3 and 10, and a sidewall having a stair-stepped configuration is illustrated in FIG. 11. The tub 30 may be formed using any suitable process, for example, injection molding or vacuum forming The tub 30 may be a separate piece from the light pipe 14. The tub 30 may be molded directly onto the light pipe 14, or the tube may be otherwise integrated with the light pipe.

The interface of the diffuser 106 and the tub 30 is illustrated in FIG. 10. The side wall 40 of the tub 30 in the area of the diffusers 106 is oriented at generally the same angle as the back of the diffusers. Consequently, light that leaks from the diffusers 106 is reflected by the side wall 40 back into the diffuser 106 for increased efficiency.

An alternative tub 130 is illustrated in FIG. 11. The side wall of the tub 130 is stair-stepped in a similar fashion to the stair-stepping 107 of the diffuser 106. The two stair-steps are offset so that light leaking or escaping through a riser of a diffuser stair-step 107 is reflected back into the diffuser 106 by a riser of a tub stair-step 131.

The visor 1 may include a switch that is actuated if the cover 2 is opened relative to the support structure 3 to thereby turn on the light source 12. A variety of switching arrangements actuated by movement of the cover 2 are illustrated in FIGS. 12-19. The switching arrangements may include, for example, a reed switch, a Hall Effect sensor, a thru-beam sensor, or IR (infrared) diffusion.

FIG. 12 illustrates a first switching arrangement including a reed switch or a Hall Effect sensor 50 and a magnet 52. The switch/sensor 50 is supported on or in the support structure 3, and the magnet 52 is supported on or in the cover 2, for example, by in-molding or over-molding. The switch/sensor 50 and the magnet 52 are located remote from the hinges 4 so that the opening and the closing of the cover 2 will cause the magnetic field around the switch/sensor 50 to decrease or increase respectively, thereby changing the status of the sensor/switch. The switch/sensor may be supported in or on the housing 13. The switch or sensor selectively permits current to flow through the light source 12.

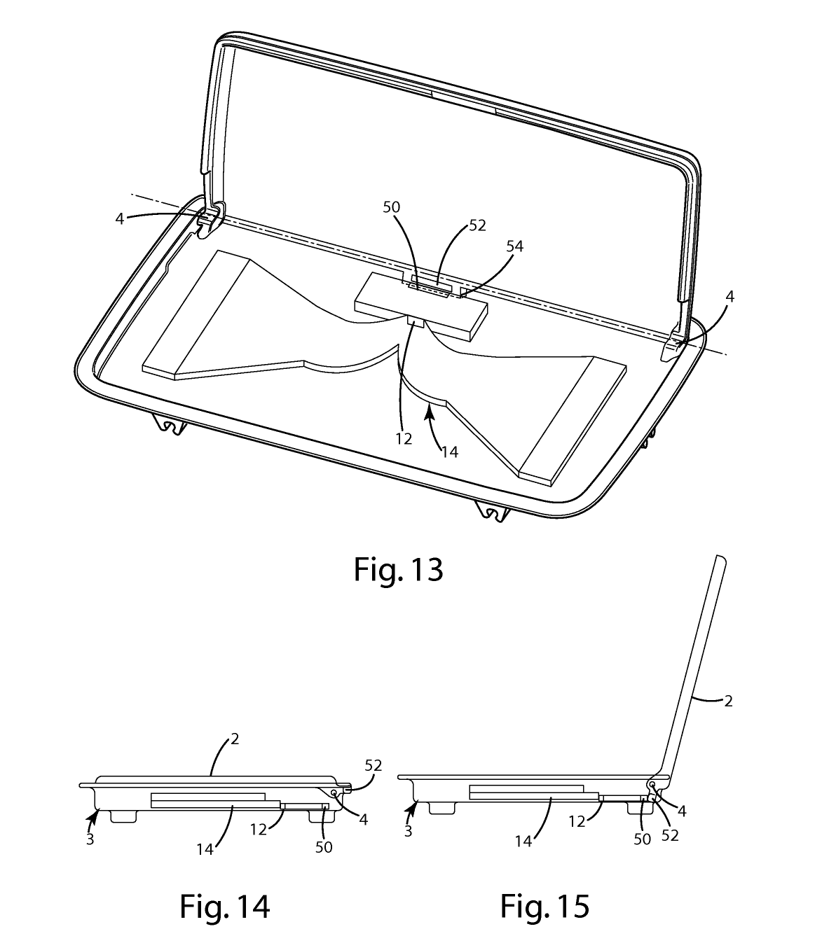

FIGS. 13-15 illustrate a second switching arrangement including different locations for the switch/sensor 50 and the magnet 52. The light pipe 14 is oriented 180 degrees opposite to the orientation illustrated in FIG. 12, so that the switch/sensor 50 is located proximate the hinge line of the cover 2. The magnet 52 is supported, for example, by in-molding or over-molding on or in a tab 54 that is integral with the cover 2. The operation of the switching arrangement is analogous to the previously described switching arrangement. When the cover 2 is closed (FIG. 14), the magnet 52 is relatively distant from the switch/sensor 50. When the cover 2 is opened (FIGS. 13 and 15), the magnet 52 is relatively close to the switch/sensor 50.

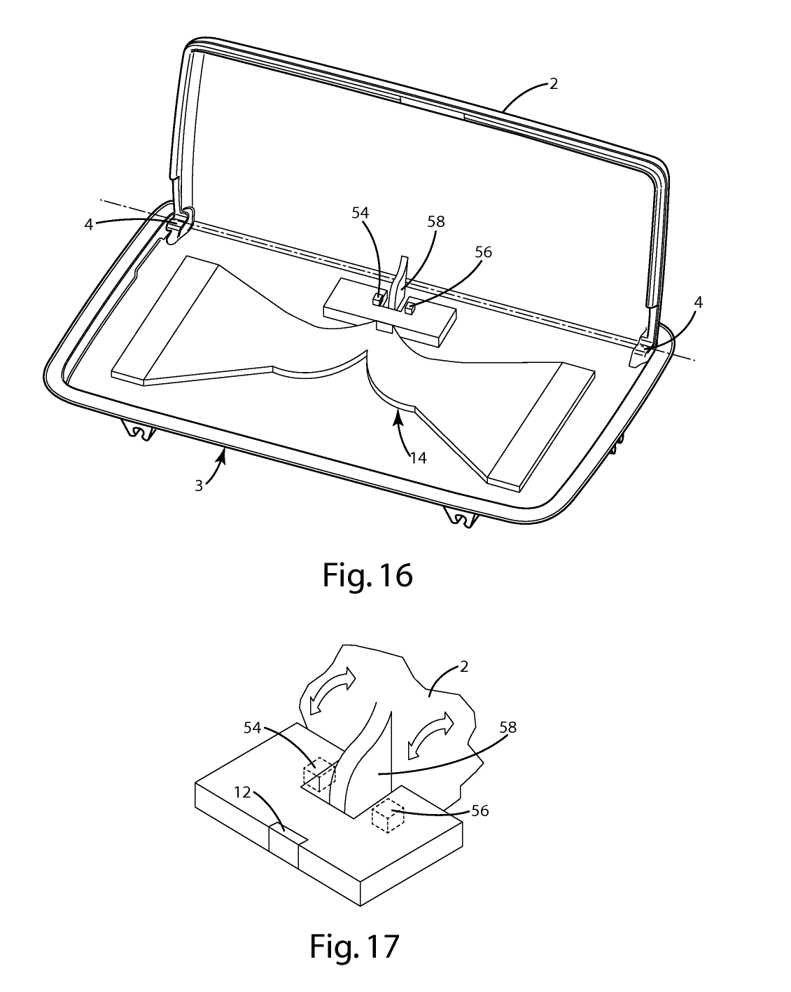

FIGS. 16-17 illustrate a third switching arrangement including an IR (infrared) emitter 54, an IR receiver 56, and a cover tab 58, which may be integrally molded with the cover 2. The cover tab 58 selectively blocks the thru-beam emitted from the emitter 54 to the receiver 56. The position of the tab 58 changes with the position of the cover 2. The tab 58 interrupts the thru-beam when the cover 2 is opened, and the tab does not interfere with the thru-beam when the cover is closed. The light source 12 will be switched on when the cover 2 is opened, and the light source will be switched off when the cover is closed. The switch components may be packaged as a module that may be over-molded within the support structure 3 and/or the cover 2. For example, the module may be nested in a pocket or dove tailed to a light distribution transmitter. The module may include all circuit components and the LED 19 for the light source 12. The LED 19 may be integrated into the switch or sensor circuit by means of trace electrical conducting material and then over-molded into one module, for example, including a PCB board.

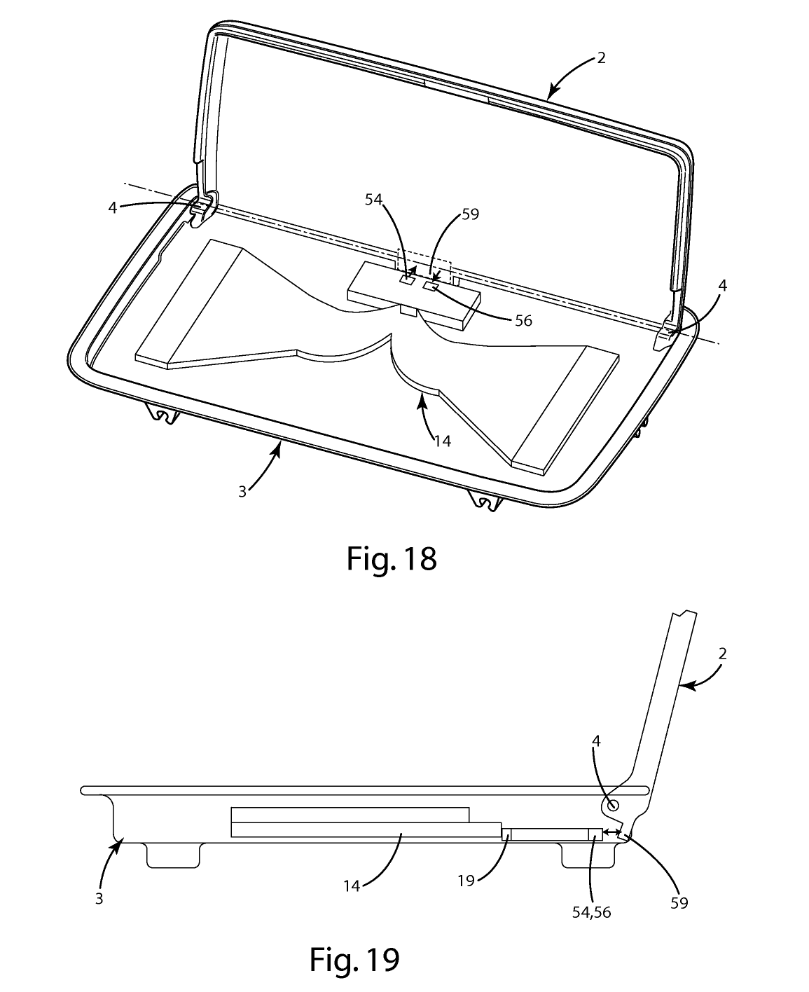

FIGS. 18-19 illustrate a fourth switching arrangement including an IR (infrared) emitter 54, an IR receiver 56, and a reflective cover tab 59, which may be integrally molded with the cover 2. The cover tab 59 selectively reflects the thru-beam emitted from the emitter 54 to the receiver 56. The position of the tab 59 changes with the position of the cover 2. The tab 59 reflects the through beam with the cover 2 is opened, and the tab does not reflect the thru-beam when the cover is closed. The light source 12 will be switched on when the cover 2 is opened, and the light source will be switched off when the cover is closed.

The concepts of the present invention may also be utilized to provide spaced apart diffusers utilizing a single light source in other applications. For example, a light pipe may be secured to a vehicle interior roof panel or structure, a door panel, the rear of a seat structure, or the like to provide a plurality of spaced apart diffusers. It will be understood that the size and shape of the light pipe will vary depending on the requirements of a particular application. Also, and as noted above, the light from the light source may be evenly split between two or more light-outputting areas, or the light may be unevenly divided as may be required or desired for a particular application.

The present invention enables a light assembly to include a single light source but multiple light outputs. This reduces the number, and consequently the cost, of light sources within a given lighting assembly. This also enables LEDs to be used more cost-effectively in lighting assemblies.

The above descriptions are those of current embodiments of the invention. Various alterations and changes may be made without departing from the spirit and broader aspects of the invention as defined in the appended claims, which are to be interpreted in accordance with the principles of patent law including the doctrine of equivalents.

The embodiments of the invention in which an exclusive property or privilege is claimed are defined as follows:

1. A vehicle component comprising:
a light source; and
a light pipe including an input and first and second outputs, the input adapted to receive light from the light source, the first and second outputs spatially separated from one another and adapted to output first and second portions respectively of the light from the light source.

2. The vehicle component of claim 1 wherein the first and second portions are substantially similar.

3. The vehicle component of claim 1 wherein the light pipe includes a central portion that receives light from the input and first and second light guide portions that extend away from the central portion to the first and second outputs respectively, the light pipe comprising a light transmitting material and including first and second oppositely facing sides having first and second side walls, the light pipe including edge surfaces extending between the opposite side walls, wherein the opposite side walls and the edge surfaces internally reflect light from the light source.

4. The vehicle component of claim 3 wherein the light guide portions are substantially symmetrical about a center line that extends through the central portion.

5. The vehicle component of claim 1 wherein the first and second outputs include first and second diffusers respectively.

6. The vehicle component of claim 5 wherein the first and second diffusers are integral with the light pipe.

7. The vehicle component of claim 5 wherein the first and second diffusers each include surface features.

8. The vehicle component of claim 7 wherein the surface features include stair-steps adapted to enhance the first-pass emission of light flux from the light source.

9. The vehicle component of claim 8 further comprising a light-reflective tray supported within the housing, the light pipe located within the tray, whereby light escaping from the light pipe is reflected by the tray back into the light pipe.

10. The vehicle component of claim 9 wherein the tray includes a sidewall proximate the first and second diffusers, the sidewall having a surface gradient.

11. The vehicle component of claim 9 wherein the tray includes a sidewall proximate the first and second diffusers, the sidewall having stair-steps offset or staggered from the diffuser stair steps.

12. The vehicle component of claim 1 wherein the light source includes at least one LED.

13. The vehicle component of claim 12 wherein:
the at least one LED is encapsulated in a light transmitting material having a light emitting surface;
the light pipe input defines a light receiving surface; and
the light emitting surface is operatively aligned with the light receiving surface.

14. The vehicle component of claim 13 wherein the light emitting surface and the light receiving surface have shapes adapted to enhance optical efficiency.

15. The vehicle component of claim 12 wherein the at least one LED is encapsulated in the input of the light pipe.

16. The vehicle component of claim 1 wherein the component is a visor vanity including a mirror.

17. A vehicle visor vanity assembly comprising:
a housing;
a mirror supported by the housing and having first and second ends;
a cover movable between a closed position covering the minor and an open position exposing the mirror;
a light source; and
a light pipe having an inlet adapted to receive light from the light source and first and second outlets proximate the adapted the first and second mirror ends respectively to output light from the light source.

18. The vehicle visor vanity assembly of claim 16 wherein the first and second light pipe outlets each include a diffuser.

19. The vehicle visor vanity assembly of claim 18 wherein the first and second diffusers are integral with the light pipe.

20. The vehicle visor vanity assembly of claim 18 wherein at least one of the diffusers includes a trademark, logo, graphic, design, or other information.

21. The vehicle visor vanity assembly of claim 17 further comprising a light-reflective tray supported within the housing, the light pipe located within the tray, whereby light escaping from the light pipe is reflected by the tray back into the light pipe.

22. A vehicle visor vanity assembly comprising:
a housing;
a mirror supported by the housing;
a lighting assembly for illuminating a space in front of the mirror;
a mirror cover movable between an open position and a closed position; and
a switch assembly operatively connected to the lighting assembly, the switch assembly including a first portion supported by the housing and a second portion supported by the mirror cover, the first and second portions cooperating to actuate the lighting assembly when the mirror cover is in the open position and to deactuate the lighting assembly when the mirror cover is in the closed position.

23. The vehicle visor vanity assembly of claim 22 wherein:
one of the first and second portions is a reed switch; and
the other of the first and second portions is a magnet.

24. The vehicle visor vanity assembly of claim 22 wherein:
one of the first and second portions is a Hall Effect sensor; and
the other of the first and second portions is a magnet.

25. The vehicle visor vanity assembly of claim 22 wherein:
one of the first and second portions is an emitter/receiver pair; and
the other of the first and second portions is a component having a first position interrupting communication between the emitter/receiver pair and a second position not interrupting communication between the emitter/receiver pair.

26. The vehicle visor vanity assembly of claim 25 wherein:
the emitter/receiver pair is a thru-beam emitter/receiver pair; and
the component is a tab.

27. The vehicle visor vanity assembly of claim 26 wherein the thru-beam emitter/receiver pair is an infrared (IR) emitter/receiver pair.

28. The vehicle visor vanity assembly of claim 25 wherein the component is a reflector.

29. The vehicle visor vanity assembly of claim 28 wherein the emitter/receiver pair is an infrared (IR) emitter/receiver pair.
